(19) United States
(12) Patent Application Publication
(10) Pub. No.: US 2026/0061461 A1
(43) Pub. Date: Mar. 5, 2026

(54) Screen device

(71) Applicant: Kleemann GmbH, Göppingen (DE)

(72) Inventor: Florian Nägele, Hüttisheim (DE)

(21) Appl. No.: 19/289,443

(22) Filed: Aug. 4, 2025

(30) Foreign Application Priority Data
Aug. 29, 2024 (DE) 10 2024 124 714.2

(51) Int. Cl. B07B 1/40; B07B 1/28; B07B 1/42

(52) U.S. Cl. CPC B07B 1/40; B07B 1/284; B07B 1/42

(57) ABSTRACT

The disclosure relates to a screen device having a screen tray in or on which at least one screen lining is disposed, wherein the screen lining can be vibrated by means of a vibratory drive, wherein the vibratory drive has two exciter units, wherein the exciter units are mechanically intercoupled by means of a synchronization device, wherein the synchronization device has two transmission elements, which can be detached in the area of a coupling point by means of a coupling device and are intercoupled for co-rotation. The assembly of such a screen device can be simplified if provision is made for an orientation aid having at least one orientation element to be provided, which is disposed and designed to orient the transmission elements with respect to each other in the area of the coupling point during the joining process of the two transmission elements.

### RELATED APPLICATION

The present application claims priority to German Patent Appl. Ser. No. DE 10 2024 124 714.2 filed Aug. 29, 2024, which is incorporated herein by reference.

### BACKGROUND OF THE DISCLOSURE

### Field of the Disclosure

The disclosure relates to a screen device having a screen tray, in or on which at least one screen lining is disposed, wherein the screen lining can be vibrated by means of a vibratory drive, wherein the vibratory drive has two exciter units, wherein the exciter units are mechanically intercoupled by means of a synchronization device, wherein the synchronization device has two transmission elements, which can be detached in the area of a coupling point by means of a coupling device and are intercoupled for co-rotation.

Such screen arrangements can be used in particular as pre-screening devices or as post-screening devices, preferably in material processing devices for processing, in particular for the comminution, of mineral materials. Accordingly, they can be disposed in the direction of the material flow of the material processing device upstream or downstream of the comminution device.

### Description of the Prior Art

Screen devices are known from the state of the art, which have two exciter units in the form of imbalance drives (“flange vibration motors”), each flanged in pairs laterally to the screen tray. To synchronize the imbalance of the left and right ends, they are interconnected for co-rotation via a split shaft having a plug-in connection and extending under a screen deck. The shaft is encompassed by a jacket tube to protect it from dirt and contact. For assembly, an imbalance drive first has to be inserted at one end. The imbalance drive is then fitted at the opposite end. To this end, the two halves of the shaft have to be placed facing each other and interconnected. A maintenance opening is provided for this purpose, through which the operator can reach and bring the two halves of the shaft together. Access to the maintenance opening is often significantly restricted due to the structural conditions. It has also been shown that the maintenance opening has to be elaborately sealed against dust ingress. It also has to be able to withstand any vibrations occurring. At least two people are always required for installation

### SUMMARY OF THE DISCLOSURE

The disclosure addresses the problem of providing a screen device of the type mentioned above, which makes for a simple assembly and maintenance of the vibratory drive.

This problem is solved by providing an orientation aid having at least one orientation element, which is disposed and designed to orient the transmission elements with respect to each other in the area of the coupling point during the joining process of the two transmission elements. This means that the transmission element(s) can be oriented in an assembly position by means of the at least one orientation element during the joining motion to enable the transmission elements to be joined, preferably without access to the coupling point from the outside. This considerably facilitates assembly. This also reduces the number of parts required, as the mounting opening can be dispensed with or at least made much simpler.

According to a possible variant of the disclosure, provision may be made for the transmission elements to each be coupled to a joint, in particular to a universal joint, facing away from the coupling point, and for an orientation element to be designed in the form of an elastic component, which braces one of the joints such that the transmission element connected to the joint is held in a joining position raised relative to the direction of gravity, or that two orientation elements are each designed in the form of an elastic component, each bracing one of the joints such that the transmission element connected to the joint is held in a joining position raised relative to the direction of gravity. The transmission elements may then be in the raised assembly position such that they are easily joined to each other or at least one further orientation element is provided, which then positions the transmission elements precisely and in the correct position in relation to each other.

A particularly cost-effective variant of the orientation aid described above results if provision is made for the universal joints to form a cardan shaft in conjunction with the transmission elements and for the orientation element to encompass at least one of the universal joints in the form of a shrink tube, at least sectionally. The shrink tube braces the universal joint, but at the same time does not impair its functionality as it is sufficiently elastic. If the shrink tube is damaged during normal operation of the screen device or loses its function in any other way, this is not of consequence as it is only required for assembly.

A particularly preferred variant of the disclosure can be such that the transmission elements each have a tube section, and that, in the area of the coupling point, the tube ends of the two tube sections are inserted into each other and interconnected in the joining area for co-rotation. In the simplest case, the tube sections are non-circular in the joining area, at least in the area of their tube ends. Thus the tube ends that are joined together are already interconnected for co-rotation due to their cross-sectional geometry. Additional fasteners are then no longer mandatory. This further reduces the number of parts and facilitates assembly work.

According to a variant of the disclosure, provision may be made for the orientation element of the orientation aid to be held by means of a fastening section in the area of a free end of the first transmission element and for the orientation element to have a centering mount, which is orientated towards the second transmission element. In this way, the second transmission element can self-orient towards the orientation element during the joining motion. The two transmission elements can then be precisely joined.

The orientation element can, for instance, be designed such that the centering mount has a funnel-like widening, in particular an inner cone, which extends at least sectionally and widens in the direction of the second transmission element. It is also conceivable that the orientation element has a centering pin or attachment, the outer circumference of which, for instance, forms the centering mount.

According to a variant of the disclosure, provision may be made for the orientation element to be designed as a molded body and to be pushed onto the free end of the first transmission member at its outer circumference, and for the molded body to preferably have a stop, which attaches the molded body to the first transmission element such that it cannot be displaced in the joining direction. In this way, the orientation element can be easily secured during installation. The molded body is preferably designed as a plastic component, preferably as a molded foam body.

The molded body may have a quality such that it is only sufficiently dimensionally stable for assembly. It is conceivable that it will then be destroyed during operation, as it is only required for mounting the two transmission elements. It can therefore be manufactured as a particularly cost-effective unit.

A screen device according to the disclosure may also be such that the orientation aid has, as an orientation element, a support body fastened to one of the transmission elements, which is supported on a component of the screen device that is stationary relative to the transmission elements, and wherein a sliding seat is provided between the orientation element and the stationary component, along which the orientation element is displaceably guided in the direction of the joining direction. This makes for a clear orientation of the transmission element. It is conceivable that the stationary component is formed by a sheathing tube, inside which the synchronization device is disposed at least sectionally.

In particular, provision may be made for the orientation element to be routed radially outwards on the inner circumferential surface of the sheathing tube in a displaceable manner in the direction of the longitudinal extent of the sheathing tube, forming a sliding fit, and for the orientation element to be preferably connected to one of the transmission elements in a non-adjustable manner in the radial direction.

To prevent incorrect assembly, provision may be made for a limiting element to be provided that limits the adjustment motion of the orientation element relative to the transmission element.

The disclosure can preferably be used in a screen device which is such that the exciter units each have a motor unit having an electric motor, each of which motor units drives a drive shaft, that the drive shafts each drive at least one imbalance weight, and that the drive shafts are mechanically intercoupled by means of the synchronization device, wherein one of the transmission elements each is coupled to each drive shaft.

### BRIEF DESCRIPTION OF THE DRAWINGS

The disclosure is explained in greater detail below based on an exemplary embodiment shown in the drawings. In the figures,

FIG. 1 is a side view of a schematic representation of a screen device in vertical section,

FIG. 2 shows a vibratory drive of the screen device as shown in FIG. 1, along the sectional line marked II-II in FIG. 1,

FIG. 3 shows a detail of the vibratory drive along the sectional line marked III-III in FIG. 1,

FIG. 4 shows a detailed representation along the sectional line marked IV-IV in FIG. 2.

FIG. 5 shows a perspective view of a fastening element,

FIG. 6 shows a side view of a synchronization device and

FIG. 7 shows the synchronization device along the sectional line marked VII-VII in FIG. 6.

### DETAILED DESCRIPTION

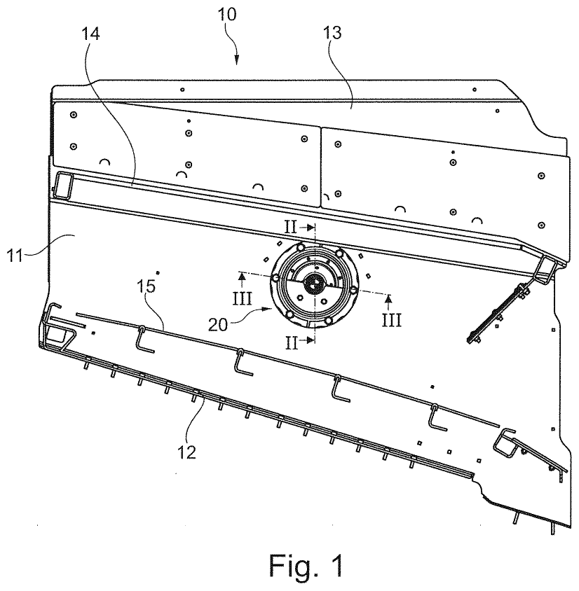

FIG. 1 shows a screen device as it is typically used in a material processing device, in particular in a rock crusher. The screen device has a screen tray 10. This screen tray 10 has two spaced-apart lateral screen panels 21, between which a screen area is formed.

At the bottom end, the screen tray 20 is closed by a bottom 12. At least one screen lining 14, 15 is disposed inside the screen tray 10 spaced apart from the bottom 12. In this exemplary embodiment, two screen bottoms 14, 15 are installed.

A conveying area 13 is formed in the area above the upper screen lining 14. During operation, the screen tray 10 is vibrated by means of a vibratory drive 20. As a result of these vibrating motions, screenings deposited on the upper screen lining 14 are conveyed along the conveying area 13, from left to right in FIG. 1. A first partial fraction is screened on the screen lining 14 and transported away via the screen lining 14. The screened material falls onto the lower screen lining 15 and is subjected to a further screening process. The screened material is transported away again on the lower screen lining 15 and the fine fractions that have fallen through the screen lining 15 are discharged via the bottom 12.

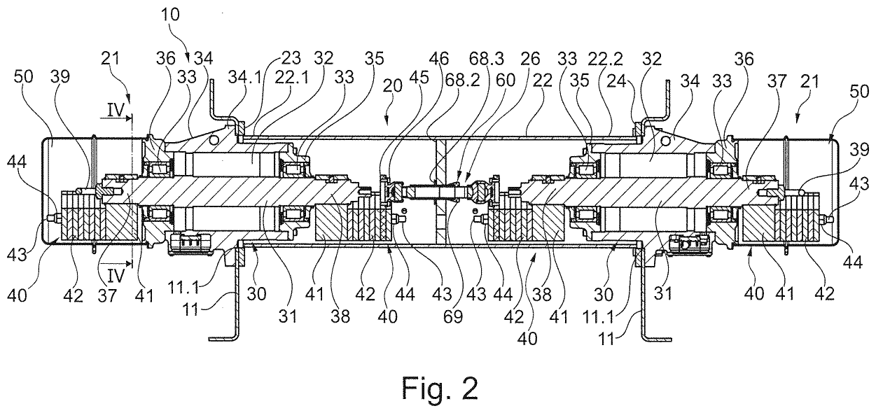

The vibratory drive 20 is illustrated in more detail in FIG. 2. As this illustration shows, the vibratory drive 20 has a modular design and has two exciter units 21. Each exciter unit 21 is attached in the area of a lateral screen panel 11. The two exciter units 21 are intercoupled via a synchronization device 26 which may also be referred to as a synchronizer 26.

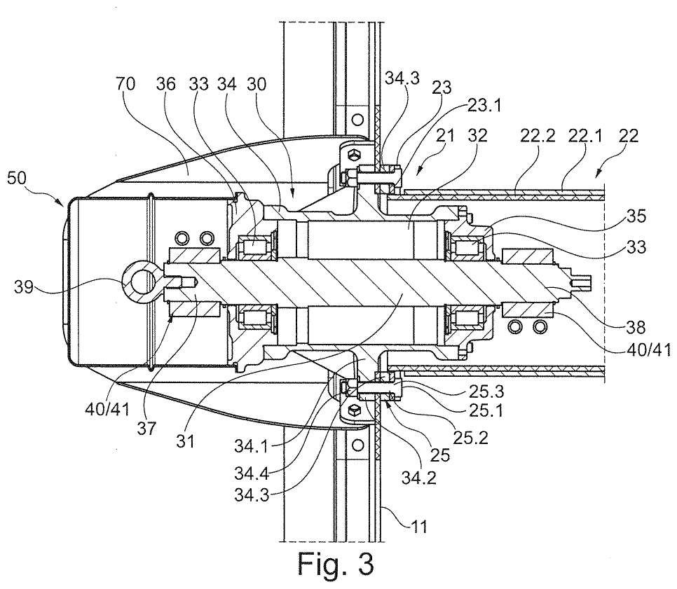

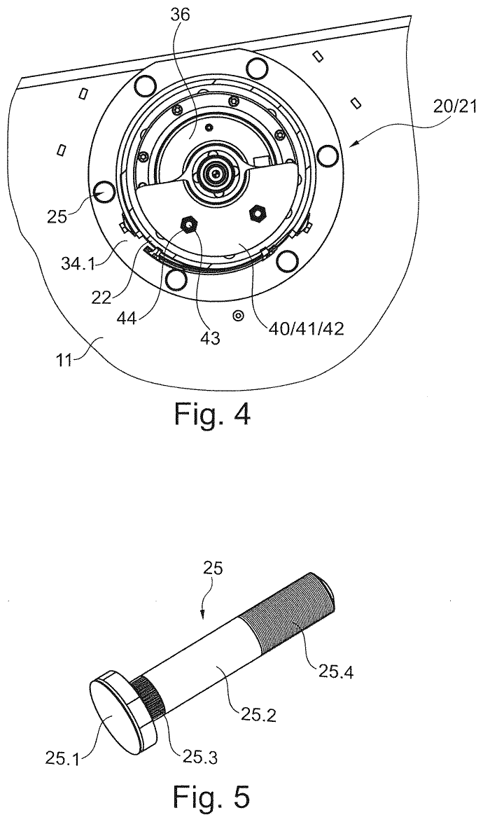

With reference to FIG. 3, first the structure of the exciter units 21 is explained in more detail. As this illustration shows, the exciter unit 21 can be designed such that it generates an imbalance by means of one or more imbalance weights 40, which are disposed eccentrically to a drive shaft 31. This imbalance generates the vibrations in the screen tray 10.

The exciter unit 21 can have a motor unit 30, which comprises the drive shaft 31. The drive shaft 31 is driven by the motor rotor of an electric motor 32. The drive shaft 31 is rotatably mounted on opposite ends of the electric motor 32 by means of bearings 33. The electric motor 32 is housed in a motor housing 34. The bearings 33 may be mounted in the motor housing 34 itself. However, it is also conceivable, as shown in FIG. 3, that separate bearing holders 35, 36 are attached to the motor housing 34, in each of which one of the bearings 33 is mounted. This allows for a modular design to be implemented, in which the prefabricated bearing holders 35, 36 can be installed from a kit having different motor housings 34.

A fastening flange 34.1 can be provided for fastening the motor unit 30 to the screen tray 10, which in particular can be integrally connected to the motor housing 34.

The motor unit 30 can preferably be fastened in an opening 11.1 in the lateral screen panel 11. The motor housing 34 can be inserted into this aperture 11.1. Holes are drilled in the lateral screen panel 11 to secure the motor unit 30. These drilled holes are aligned with holes 34.2 of the mounting flange 34.1. The motor unit 30 is fastened to the lateral screen panel 11 by means of fastening elements 25, which are inserted through the aligned drilled holes 34.2 in the lateral screen panel 11 and in the fastening flange 34.1, as will be explained in more detail below.

As further illustrated in FIG. 3, the drive shaft 31 may have a mount 37, 38 each at each of its two ends. An imbalance weight 40 is attached to each of these mounts 37, 38 for co-rotation. The imbalance weight 40 has an individual weight 41. This individual weight 41 has a drilled hole. The individual weight 41 is pushed onto the mount 37, 38 of the drive shaft 31 by means of this drilled hole.

As FIG. 2 shows, it may now be necessary to use an additional imbalance mass, depending on the system configuration. For this purpose, provision may be made, in addition to the individual weight 41, for one or more additional weights 42 to be connected directly or indirectly to the drive shaft 31 at one or both ends of the drive shaft 31 for co-rotation.

As FIG. 2 shows, the additional weight 42 can be directly connected to the individual weight 41. For this purpose, provision may be made for the individual weight 41 to be provided with a stud bolt 43, onto which a drilled hole of the additional weight 42 is pushed. This allows the additional weight 42 to be connected to the individual weight 41 by screwing a nut 44 onto the stud bolt 43, which nut securely clamps the additional weight 42 to the individual weight 41.

Preferably, the masses at both ends of the drive shaft 31 are equal or at least approximately equal to achieve an even load on the drive shaft 31.

FIG. 3 shows that the motor unit 30 can be equipped with a support device, preferably a lifting eye 39. The lifting eye 39 may be screwed into the outer end of the drive shaft 31 in the area of the mount 37. The support device can be used to attach the motor unit 31 to an auxiliary device and to handle it more easily for assembly purposes to simplify assembly.

As FIG. 2 shows, the two exciter units 21 on both ends of the screen tray 10 can be constructed similarly in principle, such that reference can be made to the above explanations. Preferably, the exciter units 21 are identical or essentially identical in design, to reduce the number of parts and assembly work.

In the area of the outside of the assigned lateral screen panel 11, a cover 50 is used to cover the exciter units 21, which cover is preferably connected to the assigned bearing holder 36. The cover 50 covers the rotating parts of the motor unit 30 on the outside precluding any risk of injury there.

FIG. 1 and FIG. 3 further illustrate that the part of the motor unit 30 projecting on the outside beyond the lateral screen panel 11 can be completely or at least largely covered by a protective cover 70 at the top in the direction of gravity. This protective cover 70 protects the motor unit 30 from the mechanical impact of falling parts. The protective cover 70 can be manufactured from a sheet steel blank as a stamped and bent part.

FIGS. 2 and 3 show that a sheathing tube 22 extends between the two lateral screen panels 11. The sheathing tube 22 has two tube sections 22.1, 22.2, which are pushed into each other. The tube sections 22.1, 22.2 of the sheathing tube 22 each have a flange 23, 24 at their end facing the lateral screen panel 11. The flanges 23, 24 are equipped with fit mounts 23.1 shaped like drilled holes (see FIG. 3).

To fasten the sheathing tube 22 between the lateral screen panels 11, the two tube sections 22.1, 22.2 are pushed into each other until the tube ends abut the flanges 23, 24. The length of the sheathing tube 22 is then smaller than the clear distance between the lateral screen panels 11. The sheathing tube 22 can thus easily be brought into the area between the lateral screen panels 11.

The fastening elements 25 already mentioned above are used to fasten the sheathing tube 22 to the lateral screen panels 11. The fastening elements 25 are designed as fit studs and are shown more clearly in FIG. 5.

As FIG. 5 shows, the fastening elements 25 have a head 25.1. This head 25.1 is integrally connected to a stud 25.2. A securing section 25.3 is formed on the stud 25.2 in the transition area between the head 25.1 and the stud 25.2. This securing section 25.3 has a surface structure having elevations and depressions. Opposite from the head 25.1, the fastening element has a threaded section 25.4.

The fastening elements 25 can be inserted stud 25 first through the fit mount 23.1 of the flange 23. In the assembled state, the securing section 25.3 comes to rest in the fit mount 23.1. The fit mount 23.1 is designed as a drilled hole, wherein the diameter of the drilled hole is smaller than the outer diameter of the securing section 25.3. Thus, the securing section 25.3 can be pressed into the fit mount 23.1, wherein the aforementioned protrusions of the securing section 25.3 dig into the inner panel of the fit mount 23.1. In this way, the securing section 25.3 forms a form-fit connection of the flange 23 and the fastening element 25 in the circumferential direction of the stud 25.2.

FIG. 3 illustrates that the stud 25.2 of the fastening elements 25 is inserted through a drilled hole in the lateral screen panel 11 and through the drilled hole 34.2 of the fastening flange 34.1 of the motor housing 34. A nut 34.4 is screwed onto the threaded section 25.4 of the fastening element 25. Thus, the fastening elements 25 can be used to connect the motor housing 34 and at the same time the assigned tube section 22.1, 22.2 to the lateral screen panel 11.

Installation is extremely simple. As mentioned above, the sheathing tube 22 only has to be placed between the two lateral screen panels 11. The two tube sections 22.1, 22.2 can be telescoped into each other to such an extent that the clear dimension between the lateral screen panels 11 is greater than the distance between the free ends of the studs 25.2 of the fastening elements 25, which are pre-mounted and fastened in the two flanges 23, 24 in the fit mounts 23.1. If the studs 25.2 are aligned with the drilled holes in the lateral screen panels 11, the tube sections 22.1, 22.2 only have to be moved outwards for the threaded sections 25.4 to be inserted through the lateral screen panels 11. The sheathing tube 22 is thus held in a pre-assembly position. Access from the inside of the screen tray 10 is then no longer required for further assembly. The assembly steps below can be performed from the outside of the screen tray 10.

In particular, the two motor units 30 can now be attached to the lateral screen panels 11 from the outside and the nuts 34.4 tightened on the outside. Because the securing section 25.3 of the fastening element 25 is held captive and non-rotatable in the flange 23, 24, the fastening element 25 no longer has to be held by the inside of the screen tray 10 when the nut 34.4 is tightened. When the nut 34.4 is tightened, the two tube sections 22.1, 22.2 are telescoped further outwards such that they can compensate for any positional tolerances of the lateral screen panels 11.

Provision may be made for sealing elements 34.3 to be disposed between the flanges 23, 24 to prevent dust from entering the area encompassed by the sheathing tube 22. The sealing element 34.3 can, for instance, be designed as a circumferential sealing ring, which is disposed between the flange 23, 24 and the inside of the lateral screen panel 11.

The two exciter units 21 are mechanically intercoupled by means of a synchronization device 26, as shown in FIG. 2. The synchronization device 26 is used to synchronize the rotary motions of the drive shafts 31 of the motor units 30.

As FIG. 2 shows, the synchronization device 26 holds the centers of gravity of the imbalance weights 40 of the exciter units 21 at identical angular positions or at least approximately at identical angular positions in the circumferential direction.

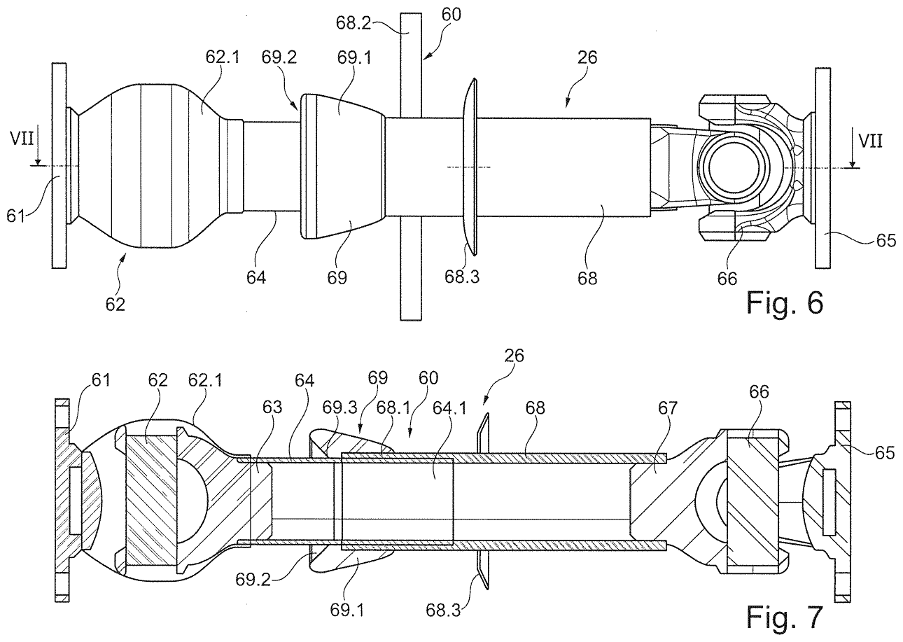

The synchronization device 26 may comprise a coupling device 60 as shown in FIGS. 6 and 7. The coupling device 60 may have coupling pieces 61, 65 at opposite ends, each of which is connected to one of the drive shafts 31 of the motor units 30 for co-rotation, as FIG. 2 shows.

For this purpose, a holder 45 can be connected to the drive shaft 31 for co-rotation. The assigned end of the coupling device 60 is connected to this holder 45 by means of screw connections 46

A universal joint 62 is connected to each of the coupling pieces 61. The universal joint 62 bears a transmission element 64 and the universal joint 66 bears a transmission element 68. The two transmission elements 64 and 68 can be interconnected, in particular for co-rotation.

The two transmission elements 64, 68 may be or have tube sections 64.1, 68.1. The tube sections 64.1, 68.1 may have a non-circular cross-section and are pushed into each other in the area of a coupling point which may also be referred to as a coupling zone, as FIG. 7 shows. The cross-sections of the tube sections 64.1, 68.1 in the joining area of the coupling point are designed such that they form a form-fit connection in the circumferential direction when joined.

As shown in FIG. 7, the universal joints 62, 66 may have fastening pieces 63, 67, which are fitted into the ends of the tube sections 64.1, 68.1 facing away from the coupling point to form a connection for co-rotation between the universal joint 62, 66 and the tube section 64.1, 68.1.

As shown in FIGS. 6 and 7, an orientation aid is used which is designed and disposed to orient at least one of the transmission elements 64, 68 in its mounting position during the joining motion during which the exciter unit 21 is mounted on the lateral screen panel 11. This oriented assembly position should be such that the two transmission elements 64, 68 are joined without the need for an operator to access the coupling point.

Preferably, the sheathing tube 22 is closed in the area of the coupling point, which significantly simplifies its design. Alternatively, provision may also be made for only an inspection opening to be incorporated into the sheathing tube 22 in the area of the coupling point to monitor the joining process and correct it if necessary.

The orientation aid has at least one orientation element 62.1, 68.2, 69.

The individual orientation elements 62.1, 68.2, 69 are explained in more detail below. As shown in FIGS. 6 and 7, the orientation element 62.1 may be formed and disposed to stabilize one of the universal joints 62, 66 in the mounting position or at least approximately in the mounting position.

For this purpose, provision may be made for the orientation element 62.1 to be designed in the form of an elastic component, which braces one of the universal joints 62, 66 such that the transmission element 64, 68 connected to the joint is held in a joining position raised relative to the direction of gravity.

As the illustrations show, the orientation element 62.1 may be formed by a plastic shrink tube, which encompasses the universal joint 62, 66. The shrink tube holds the transmission element 64 in its raised orientation relative to the direction of gravity, as shown in FIGS. 6 and 7, or at least approximately in the position shown.

Additionally or alternatively, the orientation aid can also have an orientation element 68.2, as shown in FIG. 6. This orientation element 68.2 can preferably be formed by a molded body which is pushed onto the outer circumference of one of the transmission elements 64, 68. FIG. 2 shows that the outer circumference of this orientation element 68.2 is supported on the inner contour of the sheathing tube 22. It can be supported on the inner panel of the sheathing tube 22 along the entire circumference or only along part of the circumference. In this way, the connected transmission element 68 is oriented in its mounting position or approximately in its mounting position relative to the stationary sheathing tube 22.

The transmission element 68 may also bear a limiting element 68.3. As FIG. 7 shows, the latter can be integrally connected to the transmission element 68. The limiting element 68.3 is used to limit the displacement motion of the orientation element 68.2 attached to the transmission element 68.

Additionally or alternatively, provision may be made for an orientation element 69 to be used, which is attached to one end of a transmission element 64, 68 by means of an attachment section 69.1. The mounting motion of the orientation element 69 on the transmission element 64, 68 is limited by a stop 69.3 of the orientation element 69.

For instance, this stop 69.3 may strike the free end of the transmission element 68, to which the orientation element 69 is attached. The orientation element 69 has a centering mount 69.2, which is orientated towards the second transmission element 64. This centering mount 69.2 can be designed in the form of a funnel-shaped extension, as shown in FIG. 7.

To mount the exciter units 21, one of the exciter units 21 is first mounted on the assigned lateral screen panel 11 as described above. The transmission element 64, 68 connected to this exciter unit 21 is inserted into the sheathing tube 22. If the orientation aid is such that the orientation element 62.1, which braces the universal joint 62, is used, the transmission element 64 is already oriented in its approximate mounting position.

If the orientation element 68.2 is used, the connected transmission element 68 is centered relative to the sheathing tube 22 in its approximate mounting position.

When the two exciter units 21 are now moved towards each other, the free end of the transmission element 64 penetrates into the centering mount 69.2 of the orientation element 69 and is oriented such that the two transmission elements 64, 68 can be fitted into each other, as shown in FIG. 7.

If the non-circular cross-sections of the transmission elements 64, 68 do not match exactly, this can be corrected by slightly twisting one of the exciter units 21 until there is an exact match and the transmission elements 64, 68 can finally be inserted into each other.

Finally, the fastening elements 25 can be used to clamp the exciter units 21 to the lateral screen panel 11 as explained above and the assembly is complete.

1-13. (canceled)

14. A screen device, comprising:
a screen tray;
at least one screen lining disposed in or on the screen tray;
a vibratory drive configured to vibrate the screen lining, the vibratory drive including first and second exciter units;
a synchronizer mechanically intercoupling the first and second exciter units, the synchronizer including first and second transmission elements detachably intercoupled in a coupling zone for co-rotation of the first and second transmission elements with each other; and
an orientation aid including at least one orientation element configured to orient the first and second transmission elements with respect to each other in the coupling zone during a joining of the first and second transmission elements.

15. The screen device of claim 14, further comprising:
first and second universal joints coupled with the first and second transmission elements, respectively, at ends of the first and second transmission elements facing away from the coupling zone; and
wherein the at least one orientation element is an elastic component configured to brace at least one of the first and second universal joints such that the transmission element connected to the at least one of the first and second universal joints is held in a joining position raised relative to a direction of gravity.

16. The screen device of claim 15, wherein:
the at least one orientation element includes first and second orientation elements formed as elastic components configured to brace the first and second universal joints, respectively, such that the first and second transmission elements are each held in a joining position raised relative to the direction of gravity.

17. The screen device of claim 15, wherein:
the first and second universal joints in conjunction with the first and second transmission elements form a cardan shaft; and
the at least one orientation element at least partially encompasses at least one of the universal joints in the form of a shrink tube.

18. The screen device of claim 14, wherein:
the first and second transmission elements each include a tube section, and the tube sections are inserted one into the other and are interconnected for co-rotation in the coupling zone.

19. The screen device of claim 14, wherein:
the at least one orientation element includes a fastening section fastened to a free end of the first transmission element;
the at least one orientation element includes a centering mount oriented towards the second transmission element.

20. The screen device of claim 19, wherein:
the centering mount includes a funnel-like widening which widens in a direction of the second transmission element.

21. The screen device of claim 14, wherein:
the at least one orientation element includes a molded body pushed onto a free end of the first transmission element, the molded body including a stop configured such that the molded body cannot be further displaced toward the first transmission element after the stop is engaged with the first transmission element.

22. The screen device of claim 14, wherein:
the screen device further includes a stationary component; and
the at least one orientation element includes a support body fastened to one of the first and second transmission elements, the support body being supported on the stationary component such that a sliding seat is provided between the support body and the stationary component along which the support body is displaceably guided in a joining direction during the joining of the first and second transmission elements.

23. The screen device of claim 14, further comprising:
a sheathing tube inside which the first and second transmission elements are disposed.

24. The screen device of claim 23, wherein:
the at least one orientation element is guided on an inner circumferential surface of the sheathing tube in a displaceable manner in a direction of a longitudinal extent of the sheathing tube thereby forming a sliding seat.

25. The screen device of claim 24, wherein:
the at least one orientation element is connected to one of the first and second transmission elements in a non-adjustable manner in a radial direction.

26. The screen device of claim 14, further comprising:
a limiting element configured to limit an adjustment motion of the at least one orientation element relative to at least one of the first and second transmission elements.

27. The screen device of claim 14, wherein:
the exciter units each include an electric motor driving a drive shaft, each drive shaft including at least one imbalance weight, the drive shafts of the exciter units being coupled to each other by the synchronizer; and
one of the first and second transmission elements is coupled to each drive shaft.

28. The screen device of claim 14, wherein:
the at least one orientation element is formed of a plastic material.

29. The screen device of claim 14, wherein:
the at least one orientation element is a foamed plastic part.

30. The screen device of claim 14, wherein:
the first and second transmission elements each have a different axial longitudinal extent in a direction of an axis of rotation of the synchronizer.

31. A method of assembling a vibratory drive of a screen device, the vibratory drive including first and second exciter units, the method comprising:
providing a synchronizer including first and second transmission elements;
orienting the first and second transmission elements with respect to each other with at least one orientation element; and
joining the first and second transmission elements by moving one of the first and second exciter units towards the other of the first and second exciter units while the first and second transmission elements are oriented with respect to each other by the at least one orientation element.

32. The method of claim 31, wherein:
the synchronizer includes first and second universal joints coupled with the first and second transmission elements, respectively;
the at least one orientation element is an elastic orientation element; and
the orienting includes bracing at least one of the first and second universal joints with the elastic orientation element such that the transmission element connected to the at least one of the first and second universal joints is held in a joining position raised relative to a direction of gravity.

33. The method of claim 31, wherein:
the at least one orientation element includes a support body;
the orienting includes fastening the support body to one of the first and second transmission elements and supporting the support body on a stationary component of the screen device such that a sliding seat is provided between the support body and the stationary component; and
the joining includes displaceably guiding the support body in a joining direction along the sliding seat during the joining of the first and second transmission elements.
